(19) United States
(12) Patent Application Publication
(10) Pub. No.: US 2025/0155780 A1
(43) Pub. Date: May 15, 2025

(54) ACCESSORY APPARATUS

(71) Applicant: CANON KABUSHIKI KAISHA, Tokyo (JP)

(72) Inventor: FUYA MIZUOCHI, Saitama (JP)

(21) Appl. No.: 18/928,598

(22) Filed: Oct. 28, 2024

(30) Foreign Application Priority Data
Nov. 13, 2023 (JP) 2023-192891

(51) Int. Cl. G03B 13/36; G03B 35/08

(52) U.S. Cl. CPC G03B 13/36; G03B 35/08

(57) ABSTRACT

An accessory apparatus includes a first optical system including a first optical element, a second optical system including a second optical element, a drive unit configured to move at least one of the first and second optical elements, and a processor configured to drive the drive unit to move both of the first and second optical elements in a first mode and move one of the first and second optical elements in a second mode. Optical axes of the first and second optical systems do not coincide with each other.

### BACKGROUND

### Technical Field

The present disclosure relates to an accessory apparatus.

### Description of Related Art

Conventionally, lenses with which a pair of right and left optical systems are disposed apart from each other by a predetermined distance (base length) and two image circles are formed in parallel on one image sensor have been known. With such lenses, images formed through the pair of right and left optical systems are recorded as motion images or still images for left and right eyes, respectively, and when the images are viewed by using a 3D display, VR goggles, or the like at playback, a right-eye video is projected onto the right eye of a viewer and a left-eye video is projected onto the left eye. In this state, the videos projected onto the right and left eyes have parallax due to the base length of the pair of right and left optical systems, and accordingly, the viewer can obtain a sense of depth. Japanese Patent Laid-open No. 2023-037539 discloses a lens apparatus including a mechanism configured to simultaneously adjust the focal points of a pair of right and left optical systems, and a mechanism configured to relatively adjust the right and left optical systems.

### SUMMARY

An accessory apparatus according to one aspect of the present disclosure includes a first optical system including a first optical element, a second optical system including a second optical element, a drive unit configured to move at least one of the first and second optical elements, and a processor configured to drive the drive unit to move both of the first and second optical elements in a first mode and move one of the first and second optical elements in a second mode. Optical axes of the first and second optical systems do not coincide with each other.

Further features of the disclosure will become apparent from the following description of embodiments with reference to the attached drawings.

### BRIEF DESCRIPTION OF THE DRAWINGS

FIG. 1 is a configuration diagram of a camera system of Example 1.

FIGS. 2A and 2B are explanatory diagrams of the cause of focus misalignment of right and left optical systems.

FIG. 3 is a diagram illustrating the camera system after the focus misalignment of the right and left optical systems is adjusted.

FIG. 4 is a diagram illustrating the camera system after the focus misalignment of the right and left optical systems is adjusted and focus is adjusted.

FIG. 5 is a flowchart illustrating interchangeable lens activation processing.

FIG. 6 is a flowchart illustrating interchangeable lens in-operation processing.

FIG. 7 is a flowchart illustrating recovery processing from an anomalous state in an overall focus mode.

FIG. 8 is a flowchart illustrating recovery processing from an anomalous state in a right-left focus misalignment adjustment mode.

FIG. 9 is a configuration diagram of a camera system of Example 2.

FIG. 10 is a flowchart illustrating recovery processing from an anomalous state in each mode of Example 2.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of examples according to the disclosure. Corresponding elements in respective figures will be designated by the same reference numerals, and a duplicate description thereof will be omitted.

In the lens apparatus of Japanese Patent Laid-Open No. 2023-037539, it is assumed that a member for simultaneously adjusting the focal points of the right and left pair of optical systems and a member for relatively adjusting the right and left optical systems are manually operated. Thus, if the mechanisms are electrified, situations may arise where, contrary to user's intent, one of the optical systems is driven or an anomaly occurs in one of the mechanisms, resulting in AF failing to operate or image capturing being performed while the right and left optical systems are out of focus, among other cases where appropriate image capturing cannot be performed.

### Example 1

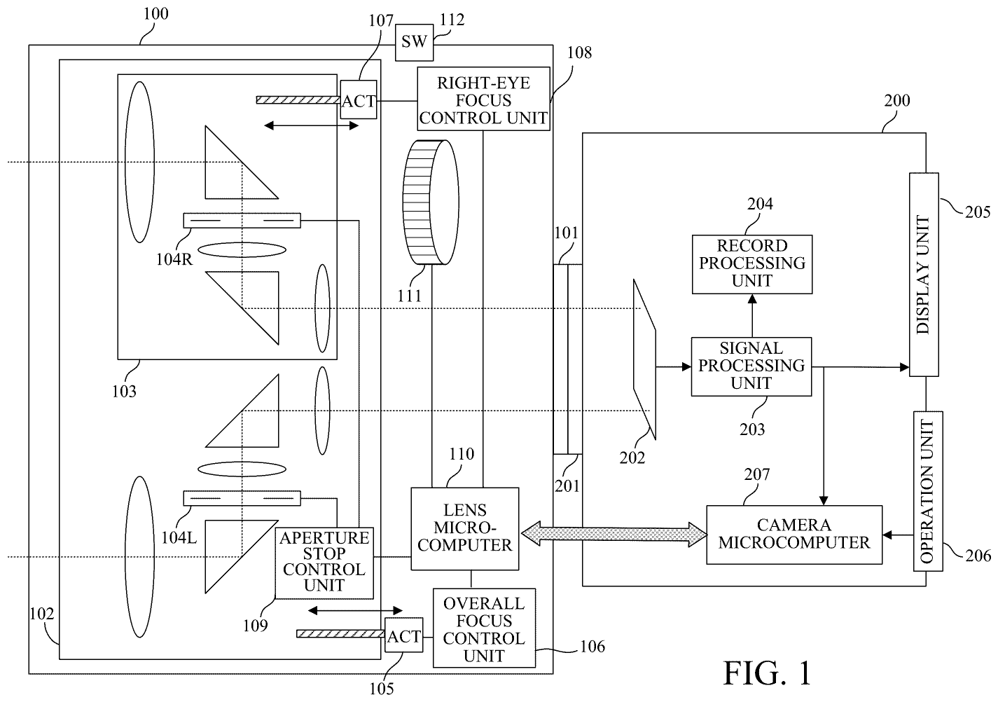

FIG. 1 is a configuration diagram of a camera system (imaging system) according to an embodiment of the present disclosure. The camera system includes an interchangeable lens (lens apparatus or accessory apparatus) 100 and a camera body (image pickup apparatus) 200. The interchangeable lens 100 is mechanically and electrically connected to the camera body 200 through an interchangeable lens mount 101 and a camera body mount 201. The interchangeable lens 100 receives supply of electric power from the camera body 200 through non-illustrated power source terminals provided on the above-described mounts. With the electric power received from the camera body 200, the interchangeable lens 100 controls various actuators and a lens microcomputer 110 to be described later. The camera body 200 communicates with the interchangeable lens 100 through non-illustrated communication terminal parts provided on the above-described mounts and controls the interchangeable lens 100 by transmitting control commands.

In the present example, the interchangeable lens 100 is attachable to the camera body 200 but may be integrated with the camera body 200. In the present example, the interchangeable lens 100 will be described as an accessory apparatus, but the present disclosure is not limited thereto. The present disclosure is also applicable to an accessory apparatus (adapter such as an extender) other than the interchangeable lens 100. The adapter is configured to be directly attachable to the camera body 200 (attachable between the camera body 200 and the interchangeable lens 100) or indirectly attachable to the camera body 200 through the interchangeable lens 100.

### <Camera Body>

The camera body 200 includes an image sensor 202 including a phase difference AF sensor or the like, a signal processing unit 203, a record processing unit 204, a display unit 205, an operation unit 206, and a camera microcomputer 207.

The image sensor 202 photoelectrically converts an object image formed through an image pickup optical system in the interchangeable lens 100 and outputs an electric signal (analog signal). The analog signal from the image sensor 202 is converted into a digital signal through a non-illustrated A/D conversion circuit.

The signal processing unit 203 generates an image signal by performing various kinds of image processing on the digital signal from the A/D conversion circuit. The signal processing unit 203 generates, from the image signal, focus information indicating the contrast state of the object image, that is, the focus state of the image pickup optical system, luminance information indicating an exposure state, and the like.

The image sensor 202 can detect the focus state of the object image by a phase difference detecting method. The signal processing unit 203 can process a phase difference signal of a pair of object images obtained from light incident through a micro lens that performs pupil division for focus detection pixels included in the image sensor 202, determine a defocus amount corresponding to the phase difference signal, and generate focus information.

The signal processing unit 203 outputs an image signal to the display unit 205, and the display unit 205 displays the image signal as a live-view image that is used to check composition, a focus state, and the like. Specifically, the display unit 205 is, for example, a rear liquid crystal display or an electronic viewfinder of the camera body 200. The signal processing unit 203 also outputs the image signal to the record processing unit 204, and the record processing unit 204 stores the image signal as still image or motion image data in a non-illustrated external memory or the like.

The camera microcomputer 207 controls the camera body 200 in accordance with inputting to an image pickup instruction switch and various setting switches included in the operation unit 206. In addition, the camera microcomputer 207 transmits, to the lens microcomputer 110, control commands related to light quantity adjustment operation of aperture stop units 104R and 104L in accordance with the luminance information and to focus adjustment operation in accordance with focus information including a defocus amount.

### <Interchangeable Lens>

The interchangeable lens 100 includes the image pickup optical system, various control units configured to control various actuators that can drive the image pickup optical system, an operation ring (operation member) 111, a SW operation unit (operation unit) 112, and the lens microcomputer 110.

The lens microcomputer 110 is a control means configured to control operation of each component in the interchangeable lens 100. The lens microcomputer 110 receives a control command transmitted from the camera body 200 and receives a lens data transmission request. The lens microcomputer 110 performs lens control corresponding to the control command and transmits lens data corresponding to the transmission request to the camera body 200. The interchangeable lens 100 has a function to transition from an active mode, which is a normal operation state, to a sleep mode, which is a low electric power consumption state, in response to a sleep command from the camera body 200. The sleep mode is a state in which electric power to peripheral circuits of the interchangeable lens 100 is cut off, a clock oscillation circuit of the lens microcomputer 110 is stopped, and operation is stopped in a low electric power consumption state. The interchangeable lens 100 transitions to the active mode in response to a sleep cancel command from the camera body 200 and performs normal operations such as focus and aperture adjustment.

The lens microcomputer 110 outputs commands to an aperture stop control unit 109, an overall focus control unit 106, and a right-eye focus control unit 108 in response to a command related to light quantity adjustment or a command related to focusing among control commands. Accordingly, the lens microcomputer 110 drives the aperture stop units 104R and 104L, an overall focus drive unit 102, and a right-eye focus drive unit 103 and performs autofocus processing that controls light quantity adjustment processing and focus adjustment operation. In addition, the lens microcomputer 110 outputs commands to the overall focus control unit 106 and the right-eye focus control unit 108 in accordance with the operation amount of the operation ring 111. Accordingly, the lens microcomputer 110 drives the overall focus drive unit 102 and the right-eye focus drive unit 103, thereby performing focus adjustment operation by what is called manual focus. The operation amount of the operation ring 111 can be calculated by computing, with the lens microcomputer 110, a signal output from a non-illustrated sensor such as a photo-interrupter.

The image pickup optical system includes a right-eye optical system and a left-eye optical system disposed in parallel to each other. In other words, optical axes of the right-eye optical system and the left-eye optical system do not coincide with each other. One of the right and left optical systems functions as a first optical system, and the other functions as a second optical system. Each optical system includes a field lens, a prism that bends and guides a light beam to the image sensor 202, and an aperture stop unit that adjusts light quantity. The right and left optical systems are disposed to form two image circles on the image sensor 202 with minimum overlapping therebetween. Two circular images formed on the image sensor 202 have parallax due to the right and left optical systems, and thus can be viewed as a VR video with a sense of depth by using a head-mounted display or the like.

When having received a focus drive command from the camera body 200, the lens microcomputer 110 outputs a command to the overall focus control unit 106 and drives an overall focus drive actuator 105. The focus drive command includes a drive amount necessary for the overall focus drive unit 102 to focus on an object based on a defocus amount calculated by the camera body 200. The overall focus drive unit 102 integrally moves the right-eye and left-eye optical systems and thus can perform focus adjustment for right and left eyes. However, since the image sensor 202 has a tilt specific to each unit as described later, focus misalignment of the right and left optical systems occurs in some cases. In this embodiment, each optical system is moved, but it is also permissible to move at least one optical element included in each optical system.

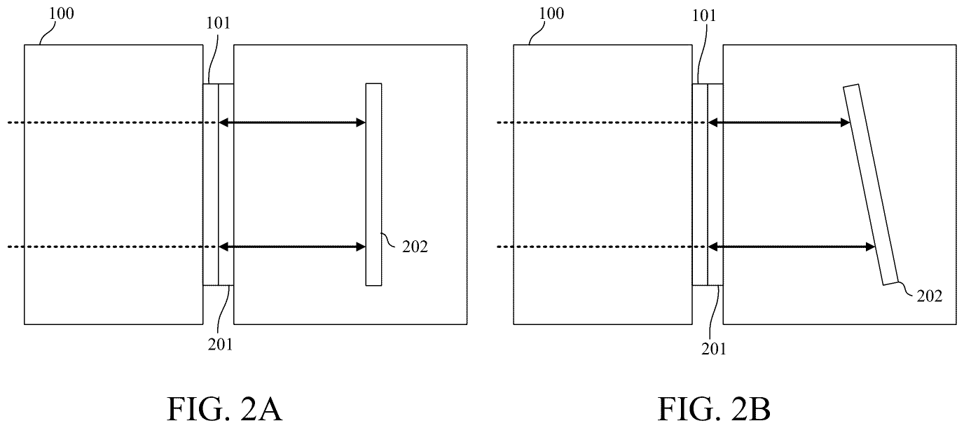

FIGS. 2A and 2B are explanatory diagrams of the cause of focus misalignment of the right and left optical systems. The right-eye and left-eye optical systems cause right-left focus misalignment in some cases because of variation in inclination of the image sensor 202 due to individual differences in the camera body 200 and reliability change (such as temperature, humidity, and impact). An ideal state is such that the image sensor 202 has a non-inclining imaging plane as illustrated in FIG. 2A, but the imaging plane inclines as illustrated in FIG. 2B due to individual differences in the camera body 200 in some cases. In focus adjustment in the state of FIG. 2B, the right and left optical systems move in the same manner, making it impossible to simultaneously align focus for the right and left. In the present example, the right-eye focus drive unit 103 is provided and thus focus misalignment of the right and left optical systems can be resolved.

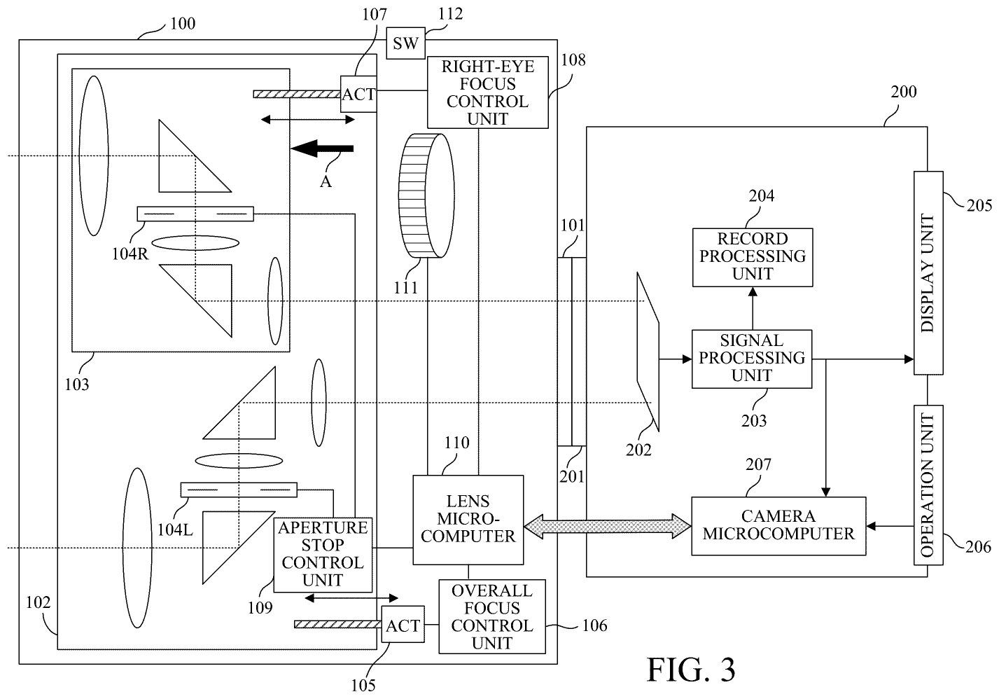

FIG. 3 is a diagram illustrating the camera system after the image sensor 202 adjusts (resolves) focus misalignment of the right and left optical systems for the camera body 200 with the imaging plane inclining as illustrated in FIG. 2B. As illustrated with arrow A, only the right-eye optical system is moved toward the object side relative to the left-eye optical system to resolve focus misalignment of the right and left optical systems. The following describes an example of operation to achieve the state of FIG. 3. A user checks focus misalignment of the right and left optical systems based on a video displayed on the display unit 205. In a case where focus misalignment of the right and left optical systems exists, the user operates the operation ring 111 to move the right-eye optical system. Accordingly, the lens microcomputer 110 acquires operation amount information of the operation ring 111 and outputs a drive command to the right-eye focus control unit 108 based on the acquired operation amount. The right-eye focus control unit 108 drives a right-eye focus drive actuator 107 that is a stepping motor in accordance with the drive command. Accordingly, the right-eye focus drive unit 103 is driven. Specifically, as a lead screw that is coaxial with a rotor of the right-eye focus drive actuator 107 rotates, the right-eye focus drive unit 103 mechanically coupled to a non-illustrated rack engaged with the lead screw drives to adjust focus. Alternatively, focus may be adjusted by rotating a non-illustrated cam barrel by a deceleration mechanism of a gear unit with drive power that rotates the stepping motor and driving the right-eye focus drive unit 103 engaged with a cam of the cam barrel in the optical axis direction to perform extending and retracting operations. The user can resolve focus misalignment of the right and left optical systems by repeating the above-described operation based on a video displayed on the display unit 205. The user starts image capturing in this state.

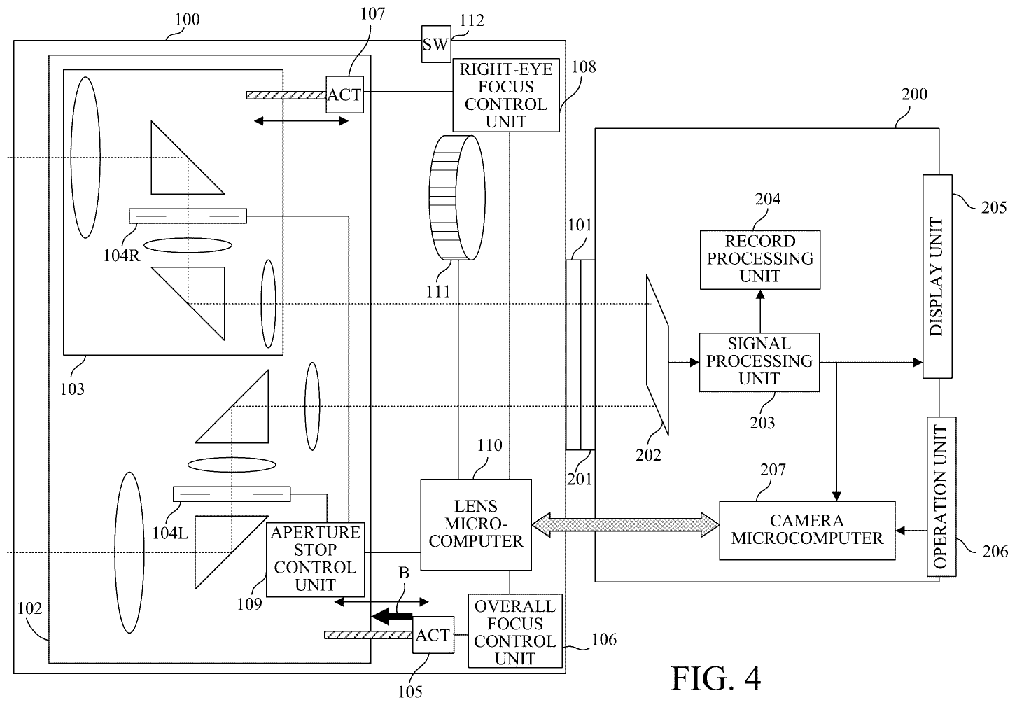

FIG. 4 is a diagram illustrating the camera system after focus misalignment of the right and left optical systems is adjusted and focus is adjusted. The positions of images formed through the right and left optical systems are adjusted by driving the overall focus drive unit 102 as illustrated with arrow B. The camera body 200 transmits a focus drive command to the interchangeable lens 100 based on a defocus amount obtained from the image sensor 202. Having received the focus drive command, the lens microcomputer 110 calculates a drive amount of the overall focus drive unit 102 and outputs a drive command to the overall focus control unit 106. The overall focus control unit 106 drives the overall focus drive actuator 105. Accordingly, the overall focus drive unit 102 is driven. The overall focus drive actuator 105 is a stepping motor in the present example but may be a VCM or an ultrasonic wave motor. The camera body 200 performs focus adjustment of the interchangeable lens 100 until the defocus amount becomes close to zero, thereby achieving autofocus.

The interchangeable lens 100 is configured to be switchable to an overall focus mode (first mode) in which the right and left optical systems are simultaneously adjusted and a right-left focus misalignment adjustment mode (second mode) in which the right and left optical systems are each relatively adjusted. The overall focus mode is a mode in which the right and left optical systems are simultaneously moved to achieve focus adjustment. The right-left focus misalignment adjustment mode is a mode in which one of the optical systems is moved relative to the other optical system to resolve focus misalignment of the right and left optical systems. The lens microcomputer 110 drives a drive unit to simultaneously move the right and left optical systems in the overall focus mode and move one of the right and left optical systems in the right-left focus misalignment adjustment mode. The drive unit is constituted by a plurality of drive units each configured to move at least one of the right and left optical systems and is constituted by the overall focus drive unit 102 and the right-eye focus drive unit 103 in the present example. The lens microcomputer 110 in the present example drives the overall focus drive unit 102 in the overall focus mode and drives the right-eye focus drive unit 103 in the right-left focus misalignment adjustment mode. The present example describes a configuration in which the right-eye optical system is moved in the right-left focus misalignment adjustment mode, but the left-eye optical system may be moved.

Mode switching is performed in accordance with the state of the SW operation unit 112 or a mode switching command from the camera body 200. In the present example, mode switching (setting) is performed in accordance with the state of the SW operation unit 112. However, actual mode transition is performed based on a switching condition to be described later, and switching is finally made to a mode in accordance with the state of the SW operation unit 112 or an instruction from the camera body 200. The mode is maintained unswitched in a case where the switching condition is not satisfied at determination, and mode transition is performed after the switching condition is satisfied. The overall focus mode is always set at activation of the interchangeable lens 100.

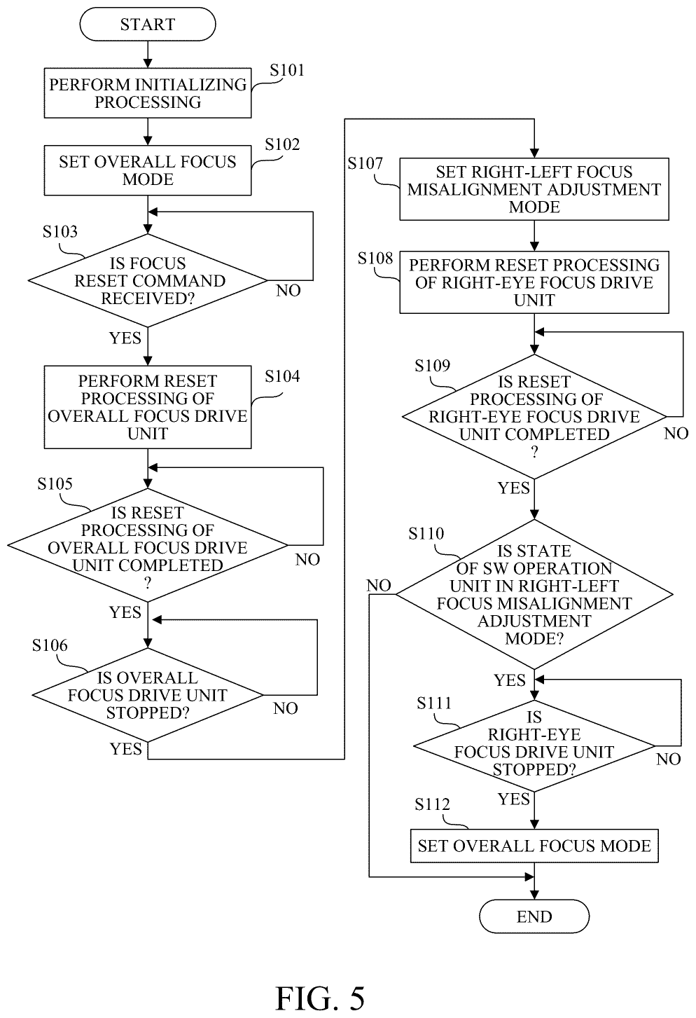

FIG. 5 is a flowchart illustrating processing (activation processing of the interchangeable lens 100) when the lens microcomputer 110 is activated after the interchangeable lens 100 is mounted on the camera body 200 and power is on.

At step S101, the lens microcomputer 110 performs initializing processing. In the initializing processing, for example, internal power supply of the interchangeable lens 100 and output reading from various sensors are performed.

At step S102, the lens microcomputer 110 sets the mode to the overall focus mode. The lens microcomputer 110 remains in this state until a focus reset command (reset processing command) is received from the camera body 200.

At step S103, the lens microcomputer 110 determines whether the focus reset command is received from the camera body 200. The lens microcomputer 110 executes processing at step S104 when having determined that the focus reset command is received, or repeats the processing at the present step when having determined otherwise.

At step S104, the lens microcomputer 110 causes the overall focus control unit 106 to perform reset processing (recovery operation) of the overall focus drive unit 102. The reset processing is processing of detecting the position of the overall focus drive unit 102 with a non-illustrated sensor such as a photo-interrupter and confirming its coordinate position.

At step S105, the lens microcomputer 110 determines whether the reset processing of the overall focus drive unit 102 is completed. The lens microcomputer 110 executes processing at step S106 when having determined that the reset processing of the overall focus drive unit 102 is completed, or repeats the processing at the present step when having determined otherwise.

At step S106, the lens microcomputer 110 determines whether the overall focus drive unit 102 is stopped. The lens microcomputer 110 executes processing at step S107 when having determined that the overall focus drive unit 102 is stopped, or repeats the processing at the present step when having determined otherwise.

At step S107, the lens microcomputer 110 switches (sets) the mode to the right-left focus misalignment adjustment mode.

At step S108, the lens microcomputer 110 causes the right-eye focus control unit 108 to perform reset processing of the right-eye focus drive unit 103. As in the case of the overall focus drive unit 102, the reset processing is processing of confirming the coordinate position of the right-eye focus drive unit 103.

At step S109, the lens microcomputer 110 determines whether the reset processing of the right-eye focus drive unit 103 is completed. The lens microcomputer 110 executes processing at step S110 when having determined that the reset processing of the right-eye focus drive unit 103 is completed, or repeats the processing at the present step when having determined otherwise.

At step S110, the lens microcomputer 110 determines whether the state of the SW operation unit 112 is in the right-left focus misalignment adjustment mode. The lens microcomputer 110 ends the present process when having determined that the state of the SW operation unit 112 is in the right-left focus misalignment adjustment mode, or executes processing at step S111 when having determined otherwise.

At step S111, the lens microcomputer 110 determines whether the right-eye focus drive unit 103 is stopped. The lens microcomputer 110 executes processing at step S112 when having determined that the right-eye focus drive unit 103 is stopped, or repeats the processing at the present step when having determined otherwise.

At step S112, the lens microcomputer 110 sets the mode to the overall focus mode.

In the activation processing of the interchangeable lens 100, the reset processing of the right-eye focus drive unit 103 does not necessarily need to be performed. Since the right-eye focus drive unit 103 needs to be adjusted when focus misalignment of the right and left optical systems is recognized by the user, the right-eye focus drive unit 103 does not need to be driven when there is no particular focus misalignment. Thus, the coordinate position of the right-eye focus drive unit 103 does not necessarily need to be confirmed, and a focus adjustment function can be achieved if only the coordinate position of the overall focus drive unit 102 is confirmed. For this reason, the activation processing of the interchangeable lens 100 may be ended after the processing at step S105.

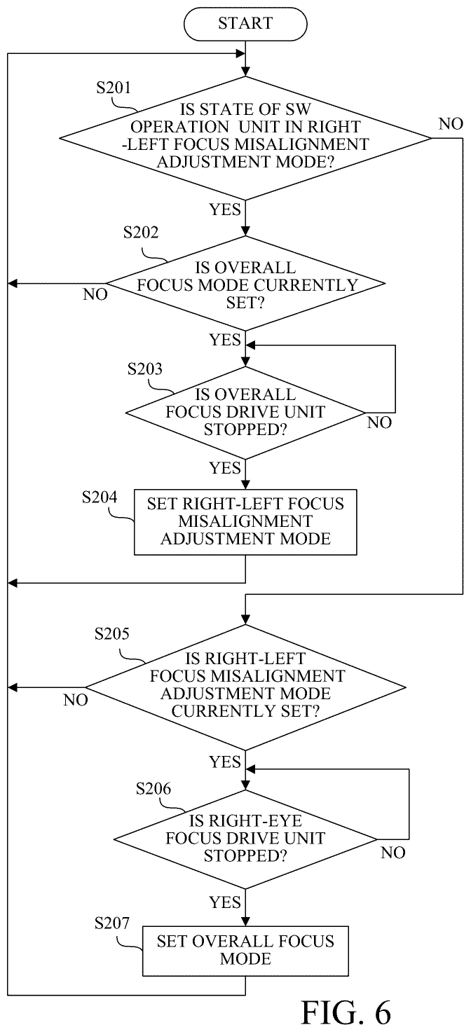

FIG. 6 is a flowchart illustrating mode transition processing (in-operation processing) during operation of the interchangeable lens 100.

At step S201, the lens microcomputer 110 determines whether the state of the SW operation unit 112 is in the right-left focus misalignment adjustment mode. The lens microcomputer 110 executes processing at step S202 when having determined that the state of the SW operation unit 112 is in the right-left focus misalignment adjustment mode, or executes processing at step S205 when having determined otherwise.

At step S202, the lens microcomputer 110 determines whether the currently set mode is the overall focus mode. The lens microcomputer 110 executes processing at step S203 when having determined that the currently set mode is the overall focus mode, or executes the processing at step S201 when having determined otherwise (the currently set mode is the right-left focus misalignment adjustment mode).

At step S203, the lens microcomputer 110 determines whether the overall focus drive unit 102 is stopped. The lens microcomputer 110 executes processing at step S204 when having determined that the overall focus drive unit 102 is stopped, or repeats the processing at the present step when having determined otherwise.

At step S204, the lens microcomputer 110 sets the mode to the right-left focus misalignment adjustment mode.

At step S205, the lens microcomputer 110 determines whether the currently set mode is the right-left focus misalignment adjustment mode. The lens microcomputer 110 executes processing at step S206 when having determined that the currently set mode is the right-left focus misalignment adjustment mode, or executes the processing at step S201 when having determined that otherwise (the currently set mode is the overall focus mode).

At step S206, the lens microcomputer 110 determines whether the right-eye focus drive unit 103 is stopped. The lens microcomputer 110 executes processing at step S207 when having determined that the right-eye focus drive unit 103 is stopped, or repeats the processing at the present step when having determined otherwise.

At step S207, the lens microcomputer 110 sets the mode to the overall focus mode.

The overall focus mode is a mode in which focus is adjusted by driving the overall focus drive unit 102 in accordance with a focus drive command from the camera body 200 or a manual focus operation with the operation ring 111. However, when a drive mechanism including the overall focus drive unit 102 is in an anomalous state, focus cannot be appropriately adjusted and thus it is needed to recover to an appropriate state. An anomalous state is, for example, step-out of a stepping motor.

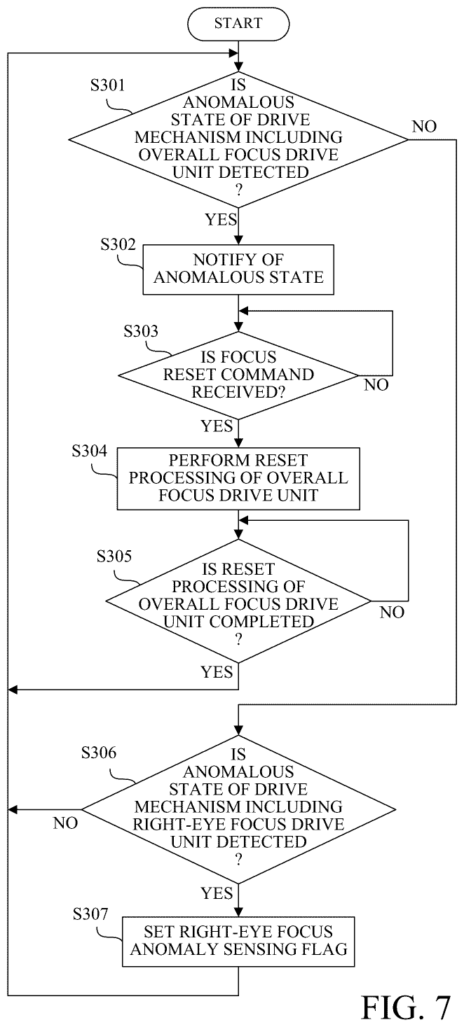

Recovery processing from an anomalous state will be described below with reference to FIG. 7. FIG. 7 is a flowchart illustrating recovery processing from an anomalous state in the overall focus mode.

At step S301, the lens microcomputer 110 determines whether an anomalous state of the drive mechanism including the overall focus drive unit 102 is detected. The lens microcomputer 110 executes processing at step S302 when having determined that an anomalous state of the drive mechanism including the overall focus drive unit 102 is detected, or executes processing at step S306 when having determined otherwise.

At step S302, the lens microcomputer 110 notifies the camera body 200 of the anomalous state of the drive mechanism.

At step S303, the lens microcomputer 110 determines whether the focus reset command is received from the camera body 200. The lens microcomputer 110 executes processing at step S304 when having determined that the focus reset command is received, or repeats the processing at the present step when having determined otherwise.

At step S304, the lens microcomputer 110 causes the overall focus control unit 106 to perform reset processing of the overall focus drive unit 102.

At step S305, the lens microcomputer 110 determines whether the reset processing of the overall focus drive unit 102 is completed. The lens microcomputer 110 executes the processing at step S301 when having determined that reset processing of the overall focus drive unit 102 is completed, or repeats the processing at the present step when having determined otherwise.

At step S306, the lens microcomputer 110 determines whether an anomalous state of a drive mechanism including the right-eye focus drive unit 103 is detected. The lens microcomputer 110 executes processing at step S307 when having determined that an anomalous state of the drive mechanism including the right-eye focus drive unit 103 is detected, or executes the processing at step S301 when having determined otherwise.

At step S307, the lens microcomputer 110 sets a right-eye focus anomaly sensing flag. In the overall focus mode, recovery processing of the right-eye focus drive unit 103 is not performed even in a case where an anomalous state of the drive mechanism including the right-eye focus drive unit 103 is detected. The recovery processing is performed upon transition to the right-left focus misalignment adjustment mode.

The right-left focus misalignment adjustment mode is a mode in which focus misalignment of the right and left optical systems is adjusted by driving the right-eye focus drive unit 103 in accordance with an operation with the operation ring 111. As in the overall focus mode, recovery operation needs to be performed in a case where an anomalous state is detected, but transition is forcibly made to the overall focus mode to prioritize correct operation of the focus adjustment function in a case where an anomalous state of the drive mechanism including the overall focus drive unit 102 is detected. Moreover, mode transition may be forcibly made to the overall focus mode in a case where the focus reset command is received from the camera body 200 in the right-left focus misalignment adjustment mode.

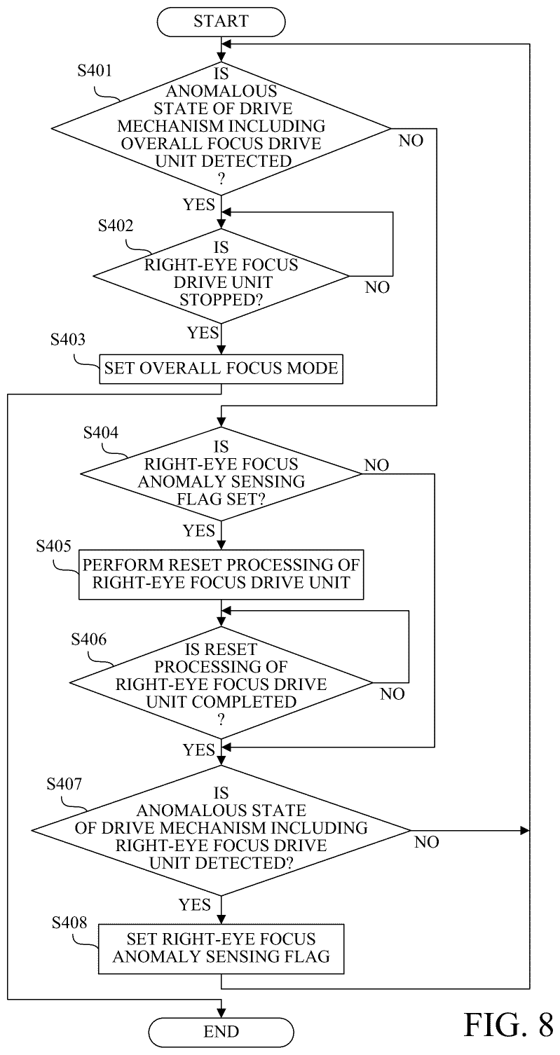

FIG. 8 is a flowchart illustrating recovery processing from an anomalous state in the right-left focus misalignment adjustment mode.

At step S401, the lens microcomputer 110 determines whether an anomalous state of the drive mechanism including the overall focus drive unit 102 is detected. The lens microcomputer 110 executes processing at step S402 when having determined that an anomalous state of the drive mechanism including the overall focus drive unit 102 is detected, or executes processing at step S404 when having determined otherwise.

At step S402, the lens microcomputer 110 determines whether the right-eye focus drive unit 103 is stopped. The lens microcomputer 110 executes processing at step S403 when having determined that the right-eye focus drive unit 103 is stopped, or repeats the processing at the present step when having determined otherwise.

At step S403, the lens microcomputer 110 sets the mode to the overall focus mode. After the overall focus mode is set, recovery processing of the drive mechanism including the overall focus drive unit 102 from an anomalous state is performed in accordance with the process of FIG. 7.

At step S404, the lens microcomputer 110 determines whether the right-eye focus anomaly sensing flag is set. The lens microcomputer 110 executes processing at step S405 when having determined that the right-eye focus anomaly sensing flag is set, or executes processing at step S407 when having determined otherwise.

At step S405, the lens microcomputer 110 causes the right-eye focus control unit 108 to perform reset processing of the right-eye focus drive unit 103.

At step S406, the lens microcomputer 110 determines whether the reset processing of the right-eye focus drive unit 103 is completed. The lens microcomputer 110 executes processing at step S407 when having determined that the reset processing of the right-eye focus drive unit 103 is completed, or repeats the processing at the present step when having determined otherwise.

At step S407, the lens microcomputer 110 determines whether an anomalous state of the drive mechanism including the right-eye focus drive unit 103 is detected. The lens microcomputer 110 executes processing at step S408 when having determined that an anomalous state of the drive mechanism including the right-eye focus drive unit 103 is detected, or executes the processing at step S401 when having determined otherwise.

At step S408, the lens microcomputer 110 sets the right-eye focus anomaly sensing flag.

As described above, according to the configuration of the present example, appropriate switching between the mode in which the right and left optical systems are simultaneously adjusted and the mode in which the right and left optical systems are each relatively adjusted makes it possible to prevent a state in which appropriate image capturing cannot be performed contrary to user's intent.

### Example 2

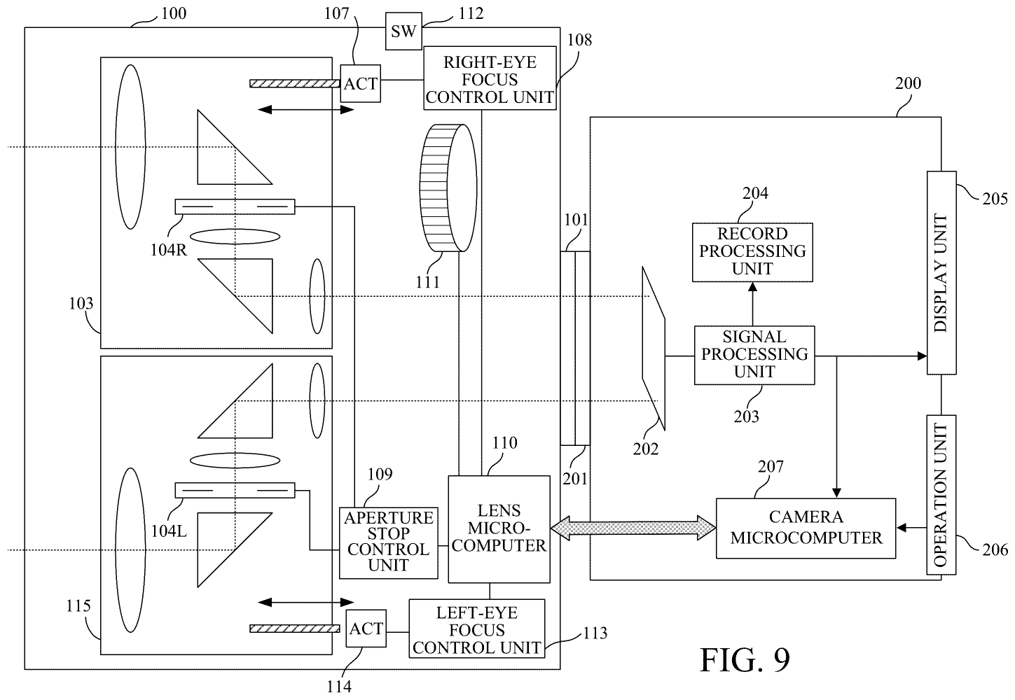

FIG. 9 is a configuration diagram of a camera system of the present example. In the present example, description is made only on any configuration different from that in Example 1, and description of any common configuration is omitted.

In the present example, the right and left optical systems are independently provided with respective actuators. The interchangeable lens 100 includes a left-eye focus control unit 113, a left-eye focus drive actuator 114, and a left-eye focus drive unit 115 in place of the overall focus control unit 106, the overall focus drive actuator 105, and the overall focus drive unit 102. In this case, in the overall focus mode, the right and left actuators need to be simultaneously driven and their drive amounts and speeds are controlled completely in synchronization therebetween. Specifically, in the present example, a drive unit is constituted by the right-eye focus drive unit 103 and the left-eye focus drive unit 115. In the present example, the lens microcomputer 110 drives the right-eye focus drive unit 103 and the left-eye focus drive unit 115 in the overall focus mode and drives the right-eye focus drive unit 103 in the right-left focus misalignment adjustment mode.

With the above-described configuration, it is possible to achieve a function equivalent to the focus adjustment described in Example 1. In Example 1, it is possible to achieve the focus adjustment function of the right and left optical systems even without executing reset processing for confirming the coordinate of the right-eye focus drive unit 103. However, in the present example, the coordinate positions of the right-eye focus drive unit 103 and the left-eye focus drive unit 115 both need to be confirmed for control in synchronization between the right and left.

Basically, it is possible to provide an equivalent function even with the configuration of the present example by performing the mode switching described above in Example 1. However, there are differences in anomaly detection of the focus drive units and the recovery method, which will be described below.

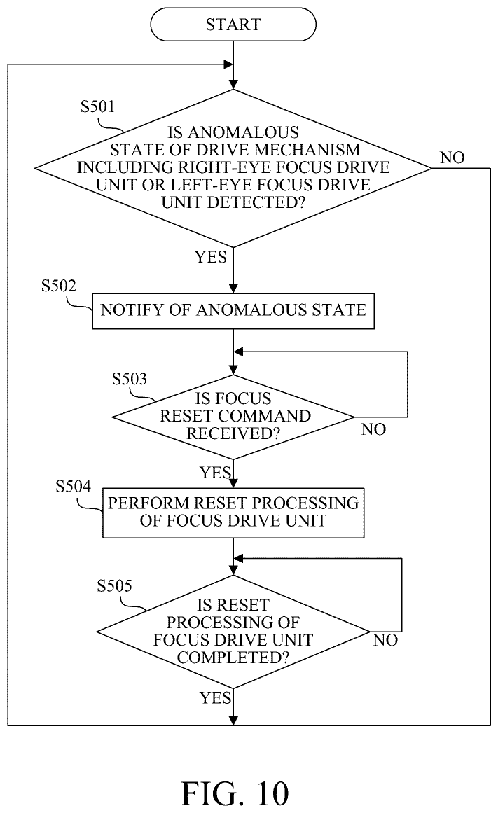

FIG. 10 is a flowchart illustrating recovery processing of a drive mechanism including a focus drive unit from an anomalous state. The same processing is performed in the overall focus mode and the right-left focus misalignment adjustment mode.

At step S501, the lens microcomputer 110 determines whether an anomalous state of the drive mechanism including the right-eye focus drive unit 103 or the left-eye focus drive unit 115 is detected. The lens microcomputer 110 executes processing at step S502 when having determined that an anomalous state of the drive mechanism including the right-eye focus drive unit 103 or the left-eye focus drive unit 115 is detected, or repeats the processing at the present step when having determined otherwise.

At step S502, the lens microcomputer 110 notifies the camera body 200 of the anomalous state.

At step S503, the lens microcomputer 110 determines whether the focus reset command is received from the camera body 200. The lens microcomputer 110 executes processing at step S504 when having determined that the focus reset command is received, or repeats the processing at the present step when having determined otherwise.

At step S504, the lens microcomputer 110 causes a focus control unit corresponding to the drive mechanism, which includes the focus drive unit for which the anomalous state is detected, to perform reset processing of the focus drive unit. For example, reset processing of both focus drive units is performed in a case where it is detected that the drive mechanisms are both in an anomalous state.

At step S505, the lens microcomputer 110 determines whether the reset processing of the focus drive unit is completed. The lens microcomputer 110 executes the processing at step S501 when having determined that the reset processing of the focus drive unit is completed, or repeats the processing at the present step when having determined otherwise.

As described above, even in a case where drive units for driving the right and left optical systems are independently provided, appropriate mode switching makes it possible to prevent a state in which appropriate image capturing cannot be performed contrary to user's intent.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

According to the present disclosure, it is possible to provide an accessory apparatus that can prevent a state in which appropriate image capturing cannot be performed.

This application claims priority to Japanese Patent Application No. 2023-192891, which was filed on Nov. 13, 2023, and which is hereby incorporated by reference herein in its entirety.

What is claimed is:

1. An accessory apparatus comprising:
a first optical system including a first optical element;
a second optical system including a second optical element;
a drive unit configured to move at least one of the first and second optical elements; and
a processor configured to drive the drive unit to move both of the first and second optical elements in a first mode and move one of the first and second optical elements in a second mode,
wherein optical axes of the first and second optical systems do not coincide with each other.

2. The accessory apparatus according to claim 1,
wherein the drive unit includes a first drive unit and a second drive unit, the first drive unit being configured to simultaneously move both of the first and second optical elements, the second drive unit being configured to move one of the first and second optical elements, and
wherein the processor drives the first drive unit in the first mode and drives the second drive unit in the second mode.

3. The accessory apparatus according to claim 1,
wherein the drive unit includes a first drive unit and a second drive unit, the first drive unit being configured to move the first optical element, the second drive unit being configured to move the second optical element, and
wherein the processor drives the first and second drive units in the first mode and drives one of the first and second drive units in the second mode.

4. The accessory apparatus according to claim 1, wherein the processor sets a mode of the accessory apparatus.

5. The accessory apparatus according to claim 4, further comprising an operation unit configured to receive setting of the mode, wherein the processor sets the mode in accordance with the mode setting received by the operation unit.

6. The accessory apparatus according to claim 4, wherein the processor acquires information related to the mode setting from the image pickup apparatus and sets the mode in accordance with the information.

7. The accessory apparatus according to claim 4, wherein the processor sets the mode to the first mode at activation of the accessory apparatus.

8. The accessory apparatus according to claim 4, wherein the processor sets the mode when the drive unit is stopped.

9. The accessory apparatus according to claim 4,
wherein the drive unit includes a plurality of drive units, and
wherein the processor sets the mode when reset processing of any drive unit that can be driven in a currently set mode among the plurality of drive units is completed.

10. The accessory apparatus according to claim 4,
wherein the drive unit includes a plurality of drive units, and
wherein the processor sets the mode to the first mode when having received, from the image pickup apparatus in the second mode, a command for reset processing of any drive unit that can be driven in the first mode among the plurality of drive units.

11. The accessory apparatus according to claim 1, further comprising an operation member that is operated by a user, wherein the processor drives the drive unit in accordance with an operation on the operation member in the first and second modes.

12. The accessory apparatus according to claim 1,
wherein the drive unit includes a plurality of drive units, and
wherein when having detected an anomaly of any drive unit that can be driven in a currently set mode among the plurality of drive units, the processor performs processing to recover from the anomaly.

13. The accessory apparatus according to claim 1,
wherein the drive unit includes a plurality of drive units, and
wherein when having detected an anomaly of a drive unit different from any drive unit that can be driven in a currently set mode among the plurality of drive units, the processor does not perform processing to recover the anomaly of the drive unit where the anomaly is detected.

14. The accessory apparatus according to claim 13, wherein when the currently set mode transitions to a mode in which the drive unit where the anomaly is detected can be driven, the processor performs processing to recover the anomaly of the drive unit for which the anomaly is detected.

15. An imaging system comprising:
the accessary according to claim 1, and
an image pickup apparatus.
